(19) United States
(12) Patent Application Publication
(10) Pub. No.: US 2009/0088917 A1
(43) Pub. Date: Apr. 2, 2009

(54) STEERING ARRANGEMENT FOR A DRIVERLESS VEHICLE

(76) Inventor: Torquil Ross-Martin, Somerset (GB)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/298,074

(22) PCT Filed: Apr. 20, 2007
(86) PCT No.: PCT/GB2007/001453

§ 371 Date: Dec. 2, 2008

(30) Foreign Application Priority Data
Apr. 24, 2006 (GB) 0608066.7

(51) Int. Cl. G05D 1/02

(52) U.S. Cl. 701/23

(57) ABSTRACT

A driverless vehicle, for example for a passenger rapid transport (PRT) system, comprises steered wheels (2, 4) which are steerable both by means of a linkage including a track rod (14) driven by a steering motor (38), and by differential torque applied by drive motors (20, 22). The motors (20, 22 and 38) are controlled in response to signals representing the deviation of the vehicle from a desired path. If either of the motor (38) or either of the motors (20, 22) fails, then steering may be maintained by the remaining motors.

This invention relates to a steering arrangement for a driverless vehicle and is particularly, although not exclusively, concerned with a driverless vehicle for use in a personal rapid transport (PRT) system.

In general, a PRT system comprises a dedicated trackway on which individual driverless vehicles travel between stations. Each vehicle contains only one passenger or group of passengers, and the vehicle travels continuously between the starting point and the destination without stopping at any intermediate stations. PRT systems thus provide a compromise between a conventional mass transport system such as buses, trains and metro systems, and individual passenger cars.

Typical PRT systems use a rail system to provide guidance for the vehicles. This may be a monorail or dual rail, and points similar to standard railway points are used to direct the vehicles at junctions.

The cost of constructing the trackway is a substantial barrier to implementing conventional PRT systems. GB 2384223 discloses a relatively low-cost track structure which does not rely on contact between the vehicle and a rail or other guidance structure. Instead, driverless vehicles travelling on the track structure have steerable wheels which are controlled in response to signals representing a predetermined travel path and/or position-sensing equipment which enables the vehicle to maintain a desired path.

Power assisted steering systems are well known in both driverless and driver controlled vehicles. In driver controlled vehicles, power-assisted steering systems are typically used to assist the driver by reducing the effort required to steer the vehicle. However, all driver controlled vehicles require the driver to provide the steering demand input, usually by means of a steering wheel. In driverless vehicles, steering demand input is typically provided by automatically generated low level mechanical or electrical steering control signals. A power assisted steering system amplifies these automatically generated signals in order to produce the forces needed to steer the vehicle.

Steering function is of importance to vehicle safety. In driver controlled road vehicles, fail-safe functioning of the steering system is provided by means of a direct mechanical linkage between the driver's steering wheel and the steered wheels. Therefore, failure of the power-assistance system does not prevent the driver from safely steering the vehicle, but does make steering more physically onerous.

In a low speed driverless vehicle, such as an automatically guided vehicle (AGV) used in industry, it is adequate to detect steering system failure and to stop the vehicle. However, in a higher speed driverless passenger vehicle, it is necessary to provide for redundancy in the steering system, enabling steering function to be maintained even after a failure affecting part of the steering system has occurred.

This invention relates to how such redundancy can be provided in a driverless vehicle's steering system by utilizing longitudinal wheel forces to influence the steering.

In this specification references to driving of the vehicle wheels, and to drive forces and torques applied to vehicle wheels are to be interpreted generally, where the context permits, to include both positive (ie driving) forces and torques, and negative (ie braking) forces and torques. Braking forces and torques may be applied by braking the drive motor of a wheel, or by a separate braking system acting on the wheel.

It is well known that differential application of torque between the left and right sides of a vehicle can be used to steer a wheeled vehicle by means of the direct effect on the total yaw moment acting on the vehicle. It is also established that, when a steering system with suitable geometry is being driven through the steered wheels, different torques applied between the steered wheels on the left and right sides of the vehicle can produce a change in steering angle and thus steer the vehicle directly.

U.S. Pat. No. 5,323,866 and U.S. Pat. No. 5,469,928 disclose power assistance steering systems for driver controlled passenger cars. In these systems the distribution of drive torque between the left and right wheels is governed principally by driver steering demand measured from steering wheel angle and/or torque. The purpose of the systems is to reduce drive steering effort and to influence the steering characteristics of the vehicle so as to make it easier to drive. If there is no driver input to the steering wheel, or if the connection between the steering wheel and the power assistance system is interrupted, the wheels will not steer.

By contrast, in a vehicle in accordance with the present invention, redundant means of steering control is provided, where the distribution of drive torque between left and right wheels is governed by the vehicle's automatic control system in response to a desired path and any error from the desired path.

According to the present invention there is provided a driverless vehicle comprising at least two steered wheels which are driveable about respective drive axes and steerable about respective steering axes by a steering mechanism, the steering geometry of the wheels being such that differences in drive torque applied to the steered wheels generate net steering torques about the steering axes, control means being provided for controlling the steering mechanism and the drive torque applied to each of the steered wheels, the control means being responsive to signals representing the steering angle of each steered wheel, a desired travel path of the vehicle and an actual travel path of the vehicle.

In a preferred embodiment the control means generates a desired steering angle based on the curvature of the desired path and the difference between the desired path and the vehicle's actual sensed or estimated path. The desired steering angle is compared with the actual steering angle to produce a steering angle error. The steering angle error is used to calculate the steering actuator effort demand (typically utilizing some form of dynamic compensation). This demanded steering actuator effort alone is sufficient to steer the vehicle through critical manoeuvres. However, the steering angle error is also used to calculate a differential drive force demand (again using some form of dynamic compensation). This differential drive force demand is applied to modify the net drive force demand (which may be calculated from error between an actual and a desired vehicle speed) to produce different drive force demands for left and right wheels. If the steering geometry is such that drive forces operate along lines of action offset from the vehicle's steering axes, these drive forces produce moments about the steering axes and a consequent net force on the steering mechanism additional to the steering actuator force. This additional net force is sufficient to steer the vehicle safely and accurately through critical manoeuvres, even should the steering actuator fail. Thus steering actuation redundancy is provided.

In a practical embodiment in accordance with the present invention, the steered wheels are the front wheels of a four-wheeled vehicle driven by the front wheels. Independent electric drives may be utilized to provide separately controllable drive torques to the front wheels.

For a better understanding of the present invention, and to show more clearly how it may be carried into effect, reference will now be made, by way of example, to the accompanying drawings, in which:

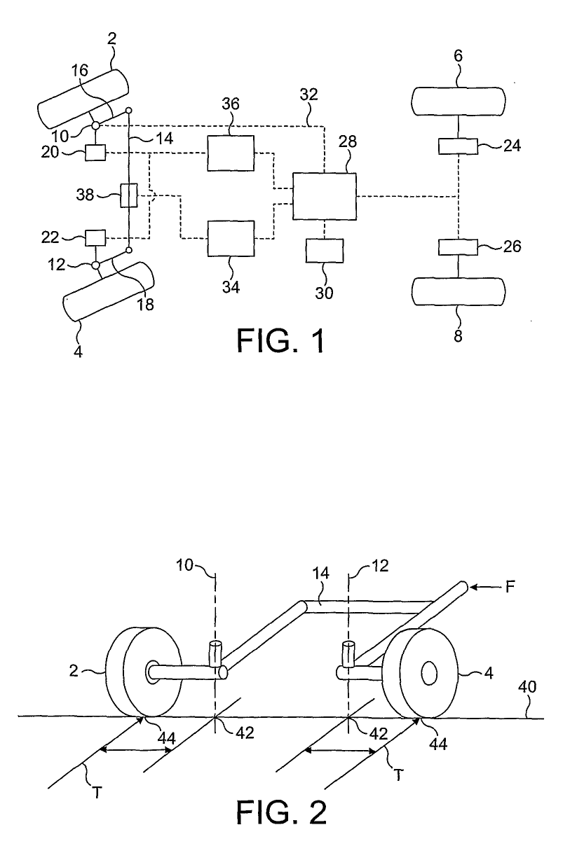

FIG. 1 is a schematic representation of a driverless vehicle;

FIG. 2 shows the steering arrangement of the vehicle of FIG. 1;

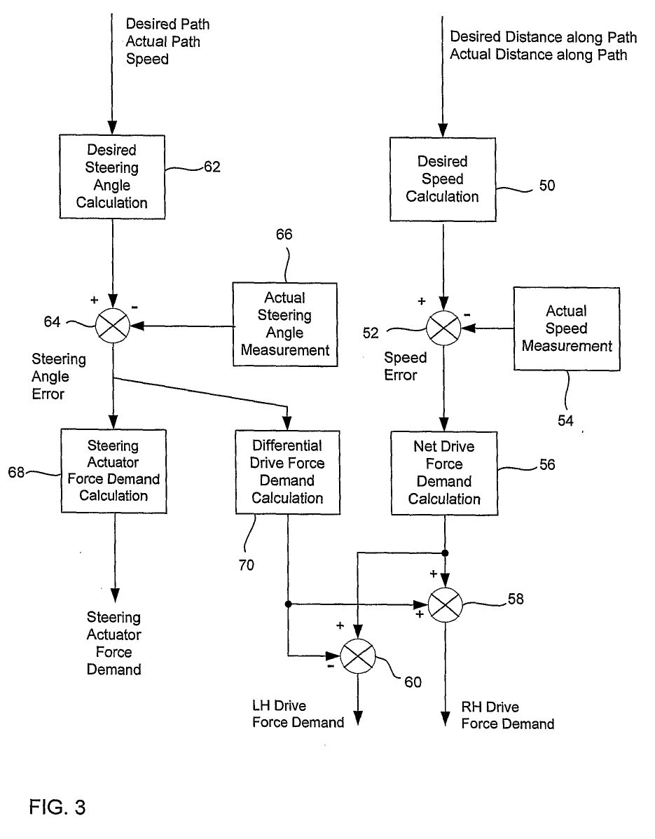

FIG. 3 is a schematic diagram representing a control system for the vehicle of FIGS. 1 and 2.

The vehicle represented in FIG. 1 may be one of a fleet of vehicles serving a PRT network. The network may comprise a trackway along which vehicles are guided, for example by a system as disclosed in our British patent application entitled ‘Vehicle Guidance System’ [Attorney's reference P103274GB00]. Thus, each vehicle may be guided along the trackway by non-contact means, under the control of its own steered wheels.

The vehicle shown in FIG. 1 comprises front steered wheels 2, 4 and rear wheels 6, 8. The steered wheels 2, 4 are mounted on the rest of the vehicle for steering movement about kingpin, or steering, axes 10, 12. Steering motion of the two wheels 2 and 4 is coordinated by a track rod 14 which interconnects steering arms 16, 18 of the wheels 2, 4 in a conventional manner.

The wheels 2, 4 can be driven in rotation by electric motors 20, 22.

Guidance of the vehicle is performed under the control of a control means 28, such as a computer. The memory of the computer 28 stores a path which the vehicle is to follow, for example the path between an originating station and a destination station of the PRT system in which the vehicle operates. The computer also receives signals from position sensing means 30 which enable the computer 28 to establish the current actual position of the vehicle. The position-sensing means 30 may be part of the computer 28, but is shown separately for clarity.

The computer 28 also receives a signal, along a line 32, representing the steering angles of the wheels 2, 4. In FIG. 1, the line 32 is shown as extending only from the kingpin 10 of the wheel 2. This may be adequate, since the track rod 14 ensures that there is a fixed relationship between the steering angles of the wheels 2 and 4, but alternatively a separate signal representing the steering angle of the wheel 4 may be input to the computer 28.

Outputs of the computer 28 are connected to a steering mechanism controller 34 and a torque controller 36. The steering mechanism controller 34 supplies control signals to a steering motor 38, and the torque controller 36 supplies control signals to the wheel motors 20, 22.

In operation of the vehicle in a PRT system, a passenger entering the vehicle at an originating station is able to specify, for example by means of a touch screen, the desired destination station. Details of the journey are then input to the computer 28, which generates a desired path along the trackway of the network from the start point to the end point.

As the vehicle proceeds along the path, the position sensing means 30 monitors the position of the vehicle both along the path, and laterally of the path. For example, the lateral position of the vehicle may be established by means of distance sensors installed on the vehicle, and capable of monitoring the distances between the sensors and a reference surface, for example a kerb, at the side of the trackway. Signals from these sensors, and possibly from other position determining equipment, such as a Global Positioning System (GPS) receiver are supplied to the position determining means 30 which then determines the current position of the vehicle and supplies a signal representing this to the computer 28. The computer 28 compares the current position with the desired position and generates an output representing a steering angle of the wheels 2, 4, which, if adopted, will bring the vehicle back to the predetermined path. This signal is compared with a signal received by the computer 28 along the line 32 representing the actual steering angles of the wheels 2, 4. If the target steering angle differs from the actual steering angle, then a correction signal is supplied to the steering mechanism controller 34 and to the torque controller 36 to cause them to generate control signals for the steering motor 38 and the electric motors 20 and 22 to cause the wheels 2, 4 to move to the target steering angle.

It will be appreciated that the steering motor 38 acts directly on the track rod 14 to cause it to turn the wheels about the kingpin axes 10, 12. The force applied by the steering motor 38 is represented by an arrow F in FIG. 2. In normal operation, this motion is assisted by a difference in the torques applied by the motors 20, 22 to the wheels 2, 4. Referring to FIG. 2, which shows a conventional steering geometry, it will be noted that the projected kingpin axis 10, 12 intersects the ground 40 at a position 42 which is offset from the nominal contact point 44 between the wheel 2, 4 and the ground 40. Consequently, traction generated at the ground 40 along the line of action T by the respective drive motor 20, 22 will tend to cause the wheel 2, 4 to turn about the kingpin axis 10, 12. If both wheels receive the same torque, the turning moments of the two wheels 2, 4 will balance each other out by way of the track rod 14, and no net turning effect will occur. However, if one of the drive motors, for example the drive motor 20, is controlled to deliver greater torque to the wheel 2 than the drive motor 22 delivers to the wheel 4, then the turning moment applied to the wheel 2 will tend to cause both wheels to turn to the left, as shown in FIG. 1. In some circumstances, torque in opposite senses may be applied to the wheels 2, 4, in other words so that one of them is driven and the other is braked.

In normal operation, this turning effect achieved by the differential torque applied by the drive motors 20, 22 will supplement the steering movement caused by the steering motor 38. However, should the steering motor 38 or the steering mechanism controller 34 fail, then steering will remain possible by appropriate control of the drive motors 20, 22 by the torque controller 36. Of course, should either of the drive motors 20, 22 fail, then drive will nevertheless be maintained through the other motor (20 or 22) while steering can be maintained by means of the steering motor 38.

Thus, the two steering systems of the vehicle can operate independently if necessary so that, in the event of failure of one of them, the other can enable the vehicle to proceed to the destination station. The vehicle can then be taken out of service for investigation and repair.

Furthermore, it will be appreciated that a speed difference between the driven wheels on opposite sides of the vehicle will have an effect on the travel direction of the vehicle even if the wheels are not steered. In a modification of the system, therefore, the torque controller 36 may be replaced by, or supplemented by, a speed controller which receives signals from the computer 28 and controls the speed of each wheel 2, 4 to assist the steering of the vehicle.

FIG. 3 is a flow chart which represents the control process carried out in the computer 28.

From the signal generated by the position-sensing means 30, the actual distance traveled along the path is determined. From the parameters of the journey itself, such as the start time and the time elapsed, the computer 28 is able to calculate the desired or expected distance traveled. Signals representing the desired and actual distances traveled are input to a desired speed calculation block 50 which calculates a desired speed, taking account of pre-set maximum and minimum acceptable speeds and acceleration levels. The output of the block 50 is passed to a subtractor which receives, as a second input, an actual speed signal from a speed sensor 54. The output of the subtractor 52 represents a speed error, and is input to a net drive force demand calculation block 56 which outputs drive force demand signals to subtractors 58, 60 associated with the right and left wheels 2, 4 respectively.

Meanwhile, signals representing the desired and actual paths and the speed of the vehicle are input to a desired steering angle calculation block 62, which calculates a desired steering angle for the wheels 2, 4 which would cause the actual path to converge on the desired path. The output of the block 62 is input to a subtractor 64, which also receives a signal (along the line 32) representing the actual steering angle of the wheels. The output of the subtractor 64 represents a steering angle error, and this is input to both a steering actuator force demand calculation block 68 and to a differential drive force demand calculation block 70.

The steering actuator force demand calculation block 60 calculates a steering actuator force demand which is input to the steering mechanism controller 36 and results in appropriate operation of the steering motor 38.

The differential drive force demand calculation block 70 calculates the difference in drive force exerted by the wheels 2, 4 required to reduce the steering angle error. The output of the block 70 is supplied to the subtractors 58, 60, which generate output signals representing right-hand and left-hand drive force demand, respectively. The signals are input to the torque controller 36, which controls the motors 20, 22 to provide the required drive forces.

1. A driverless vehicle comprising at least two steered wheels which are driveable about respective drive axes and steerable about respective steering axes by steering mechanism, the steering geometry of the wheels being such that differences in drive torque applied to the steered wheels generate net steering torques about the steering axes, control means being provided for independently controlling the steering mechanism and the drive torque applied to each of the steered wheels, the control means being responsive to signal representing the steering angle of each steered wheel, a desired travel path of the vehicle and an actual travel path of the vehicle.

2. A driverless vehicle as claimed in claim 1, in which the control means calculates from the desired and actual travel path signals a desired steering angle, the drive torque being calculated on the basis of the difference between the actual and desired steering angles.

3. A driverless vehicle as claimed in claim 1, in which the drive torques are provided wholly or in part by electric motors.

4. A driverless vehicle as claimed in claim 1, in which the control means is adapted to control the speed differential between driven wheels on opposite sides of the vehicle, thereby to cause steering of the vehicle.

5. A driverless vehicle as claimed in claim 1, in which the control means is adapted to calculate a desired steering torque, and to modulate the drive torques applied to the steered wheels in response to a difference between the actual steering torque applied by the steering mechanism and the desired steering torque.

6. A driverless vehicle as claimed in claim 1, in which demanded steering torque to be applied by the steering mechanism is adjusted in response to demanded or actual drive torque distribution.

7. A driverless vehicle as claimed in claim 1, comprising four wheels, all of which are steered.

8. A driverless vehicle as claimed in claim 1, in which the control means is adapted to control the drive torque applied to the steered wheels in response to the speed of the vehicle.

9. A driverless vehicle as claimed in claim 8, in which the control means is adapted to calculate a desired speed of the vehicle, and in which the drive torque applied to the steered wheels is controlled in response to a difference between the desired speed and the actual speed of the vehicle.

10. A driverless vehicle substantially as described herein with reference to, and as shown in, the accompanying drawings.
